(19) United States
(12) Patent Application Publication
(10) Pub. No.: US 2024/0236639 A1
(43) Pub. Date: Jul. 11, 2024

(54) ROAMING USING DISTRIBUTED ACCESS POINT MULTI-LINK DEVICE GROUPS

(71) Applicant: NXP USA, Inc., Austin, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 18/409,618

(22) Filed: Jan. 10, 2024

Related U.S. Application Data
(60) Provisional application No. 63/479,603, filed on Jan. 12, 2023.
(60) Provisional application No. 63/479,209, filed on Jan. 10, 2023.

(51) Int. Cl. H04W 8/14; H04W 76/15

(52) U.S. Cl. CPC H04W 8/14; H04W 76/15

(57) ABSTRACT

Embodiments of apparatus, system and method are disclosed. In an embodiment, a distributed access point (AP) multi-link device (MLD) apparatus comprises a roaming AP MLD having a medium access control (MAC) service access point (SAP) address, and a plurality of AP MLDs affiliated with the roaming AP MLDs, wherein at least one of the roaming AP MLD and the AP MLDs is operable to, for a multi-link setup between a non-AP MLD and the roaming AP MLD through one of the AP MLDs affiliated with the roaming AP MLD, calculates Pairwise Master Key (PMK) and Pairwise Transient Key (PTK) using the MAC SAP address of the roaming AP MLD and allow the non-AP MLD to be associated with the roaming AP MLD using the PMK and PTK for frame exchanges.

### CROSS-REFERENCE TO RELATED APPLICATIONS

This application is entitled to the benefit of U.S. Provisional Patent Application Ser. No. 63/479,209, filed on Jan. 10, 2023 and U.S. Provisional Patent Application Ser. No. 63/479,603, filed on Jan. 12, 2023, which are incorporated herein by reference.

### BACKGROUND

The use of a roaming access point (AP) multi-link device (MLD) with distributed AP MLDs at different locations may be used for smooth roaming. The distributed AP MLDs affiliated with the roaming AP MLD can cover a large area. As a result, the chance of transitioning from one roaming AP MLD to another AP MLD outside the roaming AP MLD or from one roaming AP MLD to another roaming AP MLD is decreased. When a non-AP MLD moves among the AP MLDs of the roaming AP MLD, the transition occurs without the need for reassociation.

### SUMMARY

Embodiments of apparatus, system and method are disclosed. In an embodiment, a distributed access point (AP) multi-link device (MLD) apparatus comprises a roaming AP MLD having a medium access control (MAC) service access point (SAP) address, and a plurality of AP MLDs affiliated with the roaming AP MLDs, wherein at least one of the roaming AP MLD and the AP MLDs is operable to, for a multi-link setup between a non-AP MLD and the roaming AP MLD through one of the AP MLDs affiliated with the roaming AP MLD, calculates Pairwise Master Key (PMK) and Pairwise Transient Key (PTK) using the MAC SAP address of the roaming AP MLD and allow the non-AP MLD to be associated with the roaming AP MLD using the PMK and PTK for frame exchanges.

In an embodiment, at least one of the roaming AP MLD and the AP MLDs is configured so that the roaming AP MLD is not visible to an extreme high throughput (EHT) non-AP MLD.

In an embodiment, an AP of the AP MLDs is configured to make a roaming AP MLD announcement in a Basic Multi-Link element or a Roaming Multi-Link element to indicate whether the AP is affiliated with an AP MLD that is affiliated with the roaming AP MLD.

In an embodiment, the AP of the AP MLDs is configured to make an announcement of some of the AP MLDs for roaming and their affiliated APs.

In an embodiment, the roaming AP MLD is part of extended service set (ESS) that can only have one roaming AP MLD.

In an embodiment, at least one of the roaming AP MLD and the AP MLDs is configured so that an existing resource is kept after the non-AP MLD has roamed to one of the AP MLDs unless there is a negotiation during roaming or a requirement to change the existing resource, the existing resource being a traffic identifier (TID)-to-link mapping, a block acknowledgement (BA) agreement, an enablement of emergency preparedness communications service (EPCS), a stream classification service (SCS) agreement, an individual target wake time (TWT) agreement associated with the non-AP MLD or a broadcast TWT membership associated with the non-AP MLD.

In an embodiment, at least one of the roaming AP MLD and the AP MLDs is configured so that the existing resource is changed using Roaming Request and Roaming Response frames.

In an embodiment, at least one of the roaming AP MLD and the AP MLDs is configured so that, in order to use an existing resource after roaming of the non-AP MLD to one of the AP MLDs, the existing resource needs to be renegotiated during roaming using Roaming Request and Roaming Response frames, the existing resource being a BA agreement, an enablement of EPCS, a SCS agreement, an individual TWT agreement associated with the non-AP MLD or a broadcast TWT membership associated with the non-AP MLD.

In an embodiment, at least one of the roaming AP MLD and the AP MLDs is configured so that, when roaming of the non-AP MLD to one of the AP MLDs, an existing resource needs to be renegotiated during roaming using Roaming Request and Roaming Response frames, the existing resource being a BA agreement, an enablement of EPCS, a SCS agreement, a TWT agreement associated with the non-AP MLD or a broadcast TWT membership associated with the non-AP MLD.

In an embodiment, the AP MLDs are configured so that each link of the AP MLDs has a unique link identifier (ID) value.

In an embodiment, each of the AP MLDs is configured to allocate an association identifier (AID) to the non-AP MLD that performs frame exchanges with that AP MLD.

In an embodiment, at least one of the roaming AP MLD and the AP MLDs is configured so that the non-AP MLD is allowed or not allowed to perform link level roaming using one or more announcements.

In an embodiment, at least one of the roaming AP MLD and the AP MLDs is configured so that Physical Layer Convergence Protocol (PLCP) Protocol Data Units (PPDUs) in a link pair from APs of the AP MLDs have no ending time alignment requirement to allow link level roaming even when the link pair is a non-simultaneous transmit and receive (NSTR) link pair.

In an embodiment, a method of roaming for a non-AP device involving a roaming AP MLD that is affiliated with a plurality of AP MLDs at different locations comprises, for a multi-link setup between the non-AP MLD and the roaming AP MLD through an AP MLD affiliated with the roaming AP MLD, calculating Pairwise Master Key (PMK) and Pairwise Transient Key (PTK) using a medium access control (MAC) service access point (SAP) address of the roaming AP MLD, and associating the roaming AP MLD with the non-AP MLD using the PMK and PTK for frame exchanges.

In an embodiment, the method further comprises making a roaming AP announcement so that the roaming AP MLD is not visible to an extreme high throughput (EHT) non-AP MLD.

In an embodiment, the roaming AP MLD announcement is made in a Basic Multi-Link element or a Roaming Multi-Link element by an AP to indicate whether the AP is affiliated with an AP MLD that is affiliated with the roaming AP MLD.

In an embodiment, the method further comprises keeping an existing resource after the non-AP MLD has roamed to one of the AP MLDs unless there is a negotiation during roaming or a requirement to change the existing resource, the existing resource being a traffic identifier (TID)-to-link mapping, a block acknowledgement (BA) agreement, an enablement of emergency preparedness communications service (EPCS), a stream classification service (SCS) agreement, an individual target wake time (TWT) agreement associated with the non-AP MLD or a broadcast TWT membership associated with the non-AP MLD.

In an embodiment, the method further comprises changing the existing resource using Roaming Request and Roaming Response frames.

In an embodiment, the method further comprises defining PPDUs in a link pair from APs of the AP MLDs to have no ending time alignment requirement to allow link level roaming even when the link pair is a NSTR link pair.

In an embodiment, a multi-link communications system comprises a roaming AP MLD having a medium access control (MAC) service access point (SAP) address, and a plurality of AP MLDs affiliated with the roaming AP MLDs, each of the AP MLDs including APs, wherein PMK and PTK used by at least one of the roaming AP MLD and the AP MLDs are calculated using the MAC SAP address of the roaming AP MLD and a non-AP MLD is associated with the roaming AP MLD when the non-AP MLD has established a multi-link connection with the roaming AP MLD through an AP MLD affiliated with the roaming AP MLD.

Other aspects in accordance with the invention will become apparent from the following detailed description, taken in conjunction with the accompanying drawings, illustrated by way of example of the principles of the invention.

### BRIEF DESCRIPTION OF DRAWINGS

FIG. 1 depicts a multi-link communications system for wireless communications that can be used in embodiments of the invention.

FIG. 2 illustrates an MLD level roaming operation in a multi-link communications system in accordance with an embodiment of the invention.

FIG. 3 illustrates a distributed AP MLD group with a reporting AP MLD and reported AP MLDs in accordance with an embodiment of the invention.

FIG. 4 illustrates a roaming operation between a roaming AP MLD and an ultra-high reliability (UHR) AP MLD in accordance with an embodiment of the invention.

FIG. 5 illustrates a roaming operation between two roaming AP MLDs in accordance with an embodiment of the invention.

FIG. 6 illustrates an MLD level roaming operation sequence in accordance with an embodiment of the invention.

FIG. 7 illustrates a link level roaming operation sequence in accordance with an embodiment of the invention.

FIG. 8 illustrates a roaming recommendation operation in accordance with an embodiment of the invention.

FIG. 9 illustrates a Fast BSS transition (FT) operation between a roaming AP MLD and an extreme high throughput (EHT) AP MLD in accordance with an embodiment of the invention.

FIG. 10 illustrates a flow diagram of a method of roaming for a non-AP device involving a roaming AP MLD that is affiliated with a plurality of AP MLDs at different locations in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

Several aspects of WiFi systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

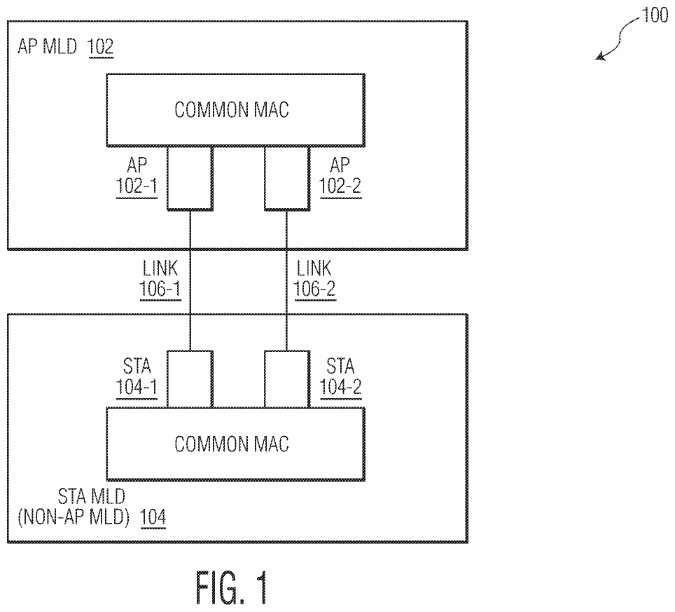

FIG. 1 depicts a multi-link communications system 100 for wireless (e.g., WiFi) communications that can be used in embodiments of the invention. In the embodiment depicted in FIG. 1, the multi-link communications system includes one access point (AP) multi-link device (MLD) 102, and one station (STA) MLD (non-AP MLD) 104. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Various iterations of the 802.11 specification are referred to herein. IEEE 802.11ac is referred to as very high throughput (VHT). IEEE 802.11ax is referred to as high efficiency (HE). IEEE 802.11be is referred to as extreme high throughput (EHT). IEEE 802.11bn is referred to as ultra-high reliability (UHR). The terms VHT, HE, EHT, and UHR may be used in the descriptions found herein.

Although the depicted multi-link communications system 100 is shown in FIG. 1 with certain components and described with certain functionality herein, other embodiments of the multi-link communications system may include fewer or more components to implement the same, less, or more functionality. For example, in some embodiments, the multi-link communications system includes a single AP MLD and multiple associated STA MLDs, or multiple AP MLDs and multiple STA MLDs with each STA MLD being associated with an AP MLD. In some embodiments, the legacy STAs (non-HE STAs) associate with one of the APs affiliated with the AP MLD. In some embodiments, an AP MLD may have a single affiliated AP. In some embodiments, a STA MLD may have a single affiliated STA. In another example, although the multi-link communications system is shown in FIG. 1 as being connected in a certain topology, the network topology of the multi-link communications system is not limited to the topology shown in FIG. 1.

In the embodiment depicted in FIG. 1, the AP MLD 102 includes two access points (APs) 102-1 and 102-2. In some embodiments, the AP MLD 102 implements upper layer Media Access Control (MAC) functionalities (e.g., association establishment, reordering of frames, etc.) and the APs 102-1 and 102-2 implement lower layer MAC functionalities (e.g., backoff, frame transmission, frame reception, etc.). The 102-1 and 102-2 may be implemented in hardware (e.g., circuits), software, firmware, or a combination thereof. The APs 102-1 and 102-2 may be fully or partially implemented as an integrated circuit (IC) device. In some embodiments, the APs 102-1 and 102-2 may be wireless APs compatible with at least one WLAN communications protocol (e.g., at least one IEEE 802.11 protocol). For example, the APs 102-1 and 102-2 may be wireless APs compatible with the IEEE 802.11bn protocol.

In some embodiments, an AP MLD 102 connects to a local area network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 102-1 and/or AP2 102-2) includes multiple RF chains. In some embodiments, an AP (e.g., AP1 102-1 and/or AP2 102-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 102-1 and 102-2 of the AP MLD 102 with multiple RF chains may operate in a different basic service set (BSS) operating channel (in a different link). For example, AP1 102-1 may operate in a 320 MHz BSS operating channel at 6 GHz band, and AP2 102-2 may operate in a 160 MHz BSS operating channel at 5 GHz band. Although the AP MLD 102 is shown in FIG. 1 as including two APs, other embodiments of the AP MLD 102 may include only one AP or more than two APs.

In the embodiment depicted in FIG. 1, the non-AP STA MLD 104 includes two non-AP STAs 104-1 and 104-2. The STAs 104-1 and 104-2 may be implemented in hardware (e.g., circuits), software, firmware, or a combination thereof. The STAs 104-1 and 104-2 may be fully or partially implemented as an IC device. In some embodiments, the STAs 104-1 and 104-2 are part of the STA MLD 104, such that the STA MLD may be a communications device that wirelessly connects to a wireless AP MLD. For example, the STA MLD 104 may be implemented in a laptop, a desktop personal computer (PC), a mobile phone, or other communications device that supports at least one WLAN communications protocol. In some embodiments, the non-AP STA MLD 104 is a communications device compatible with at least one IEEE 802.11 protocol (e.g., an IEEE 802.11bn protocol, an IEEE 802.11be protocol, an IEEE 802.11ax protocol, or an IEEE 802.11ac protocol). In some embodiments, the STA MLD 104 implements a common MAC functionality and the non-AP STAs 104-1 and 104-2 implement a lower layer MAC data functionality.

In some embodiments, the AP MLD 102 and/or the STA MLD 104 may identify which communication links support multi-link operation during a multi-link operation setup phase and/or exchanges information regarding multi-link capabilities during the multi-link operation setup phase. In some embodiments, each of the non-AP STAs 104-1 and 104-2 of the STA MLD 104 may operate in a different frequency band. For example, the non-AP STA 104-1 in one link may operate in the 2.4 GHz frequency band and the non-AP STA 104-2 in another link may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 1, the STA MLD 104 communicates with the AP MLD 102 via two communication links 106-1 and 106-2. For example, each of the non-AP STAs 104-1 and 104-2 communicates with an AP 102-1 or 102-2 via a corresponding communication link 106-1 or 106-2. In an embodiment, a communication link (e.g., link 106-1 or link 106-2) may include a BSS operating channel established by an AP (e.g., AP 102-1 or AP 102-2) that features multiple 20 MHz channels used to transmit frames (e.g., Beacon frames, management frames, etc.) being carried in Physical Layer Convergence Protocol (PLCP) Protocol Data Units (PPDUs) between a first wireless device (e.g., an AP, an AP MLD, an STA, or an STA MLD) and a second wireless device (e.g., an AP, an AP MLD, an STA, or an STA MLD). In some embodiments, a 20 MHz channel may be a punctured 20 MHz channel or an unpunctured 20 MHz channel. Although the STA MLD 104 is shown in FIG. 1 as including two non-AP STAs, other embodiments of the STA MLD 13 may include one non-AP STA or more than two non-AP STAs. In addition, although the AP MLD 102 communicates (e.g., wirelessly communicates) with the STA MLD 104 via multiple links 106 and 106-2, in other embodiments, the AP MLD 102 may communicate (e.g., wirelessly communicate) with the STA MLD 104 via one communication link or more than two communication links.

As described above a multi-link AP MLD has one or multiple links where each link has one AP affiliated with the AP MLD. This may be accomplished by having the different radios for the different affiliated APs. A multi-link STA MLD has one or multiple links where each link has one STA affiliated with the STA MLD. One way to implement the multi-link STA MLD is using two or more radios, where each radio is associated with a specific link. For example, a multi-link multi-radio (MLMR) non-AP MLD may be used. The MLMR non-AP MLD uses multiple full functional radios to monitor the medium in multiple links. Another way to implement the multi-link STA MLD is using a single radio in two different bands. Each band may be associated with a specific link. In this case, only one link is available at a time. In yet another implementation, an enhanced single-radio (ESR) STA MLD may be used that operates in an enhanced multi-link single radio (eMLSR) mode. The ESR STA MLD uses two radios in different bands to implement the MLD. For example, one radio may be a lower cost radio with lesser capabilities and the other radio may be a fully functional radio supporting the latest protocols. The ESR STA MLD may dynamically switch its working link while it can only transmit or receive through one link at any time. The ESR STA MLD may monitor two links simultaneously, for example, detecting medium idle/busy status of each link, or receiving a PPDU on each link. Each radio may have its own backoff time, and when the backoff counter for one of the radios becomes zero, that radio and link may be used for transmission. For example, if an AP wants to use the fully functional radio, it may send a control frame that is long enough for the ESR STA MLD to switch from the lesser capable radio to the fully functional radio that may then transmit data to the AP. When an extended service set (ESS) includes multiple AP MLDs in different locations and a STA MLD executed the data frame exchanges with one of the AP MLDs (e.g., AP MLD1), as the STA MLD moves to other location to do the data frame exchanges with another one of the AP MLDs (say AP MLD2), the STA MLD (same as a non-AP MLD herein) needs to finish the association with AP MLD2 before doing the data frame exchanges with AP MLD2. There is a requirement to decrease the number of associations within the ESS.

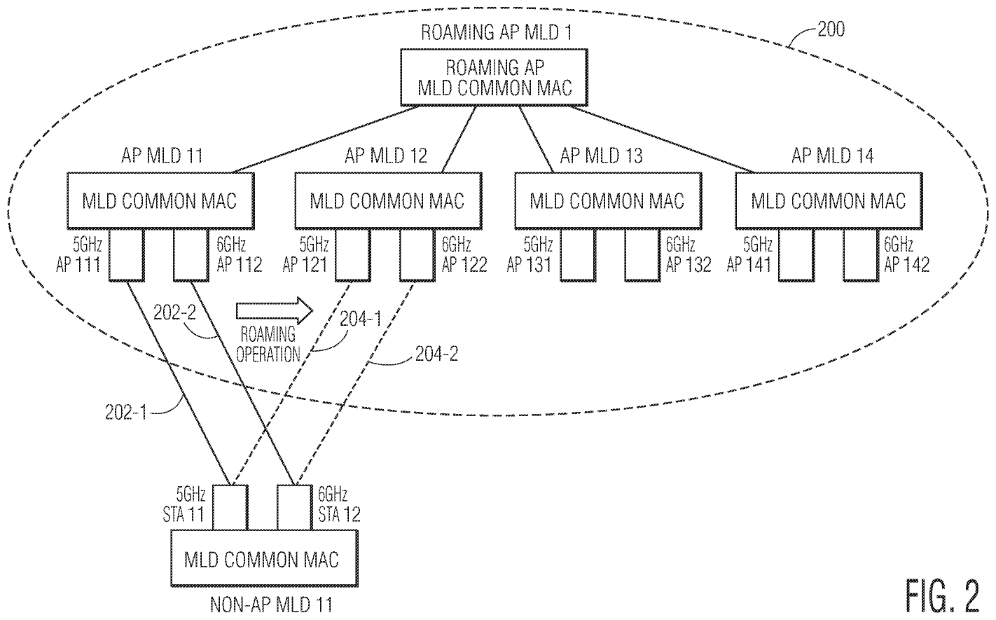

FIG. 2 illustrates an MLD level roaming operation in a multi-link communications system 100 in accordance with an embodiment of the invention. A roaming AP MLD 1 includes a number of different AP MLDs in different physical locations that operate together and have a common MAC service access point (SAP) address. The roaming AP MLD 1 is affiliated with AP MLD 11, AP MLD 12, AP MLD 13 and AP MLD 14, which are collectively referred to herein as a distributed AP MLD apparatus or group 200. In an embodiment, the distributed AP MLD group may be an ESS or part of an ESS. The AP MLD 11 includes 5 GHz AP 111 and 6 Ghz AP 112. The AP MLD 12 includes 5 GHz AP 121 and 6 Ghz AP 122. The AP MLD 13 includes 5 GHz AP 131 and 6 Ghz AP 132. The AP MLD 14 includes 5 GHz AP 141 and 6 Ghz AP 142. In FIG. 2, there is a non-AP MLD 11 that includes 5 GHz STA 11 and 6 GHz STA 12, which has established a multi-link association with the roaming AP MLD 1 with the AP MLD 12 as the serving AP MLD. There are two links 202-1 and 202-2 between AP MLD 11 and the non-AP MLD 11. The link 202-1 is between the 5 GHz AP 111 and the 5 GHz STA 11. The link 202-2 is between the 6 Ghz AP 112 and the 6 GHz STA 12. Thus, the non-AP MLD 11 can execute data frame exchanges with the serving AP MLD 11 affiliated with the roaming AP MLD 1.

The non-AP MLD 11 may be mobile and can move relative to the roaming AP MLD 1. Therefore, the non-AP MLD 11 may roam from one AP MLD (i.e., the current serving AP MLD) affiliated with the AP MLD 1 to another AP MLD (i.e., future serving AP MLD) affiliated with the roaming AP MLD 1 without the need for reassociation. FIG. 2 illustrates the non-AP MLD 11 roaming from the AP MLD 11 to the AP MLD 12. In this case, new links 204-1 and 204-2 are established between the AP MLD 12 and then non-AP MLD 11, and the frame exchange context of the non-AP MLD 11 is transferred to the AP MLD 12 from the AP MLD 11 for the frame exchanges with the non-AP MLD 11. Accordingly, the frame exchange context with the non-AP MLD 11 is established in the new serving AP MLD 12. The link 204-1 is between the 5 GHz AP 121 and the 5 GHz STA 11, and the link 204-2 is between the 6 Ghz AP 122 and the 6 GHz STA 12.

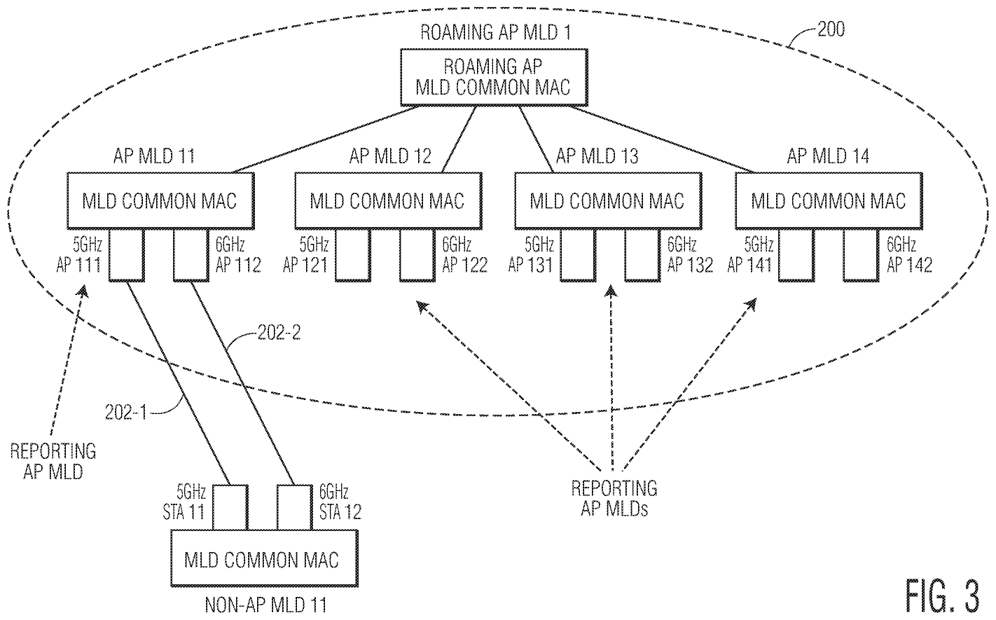

In some embodiments, each AP MLD in a distributed AP MLD group, such as the distributed AP MLD group 200, has a unique ID. This unique ID has a different MLD ID space from the AP MLD ID space for the AP MLDs in one AP device. The roaming AP MLD has one MAC SAP address, i.e., a distributed AP MLD MAC SAP address. In an embodiment, a UHR non-AP MLD uses the MAC SAP address of the roaming AP MLD as the interface to be presented to the up layer (i.e., to the distributed system (DS)). The AP MLD (1^{st} AP MLD) whose AP is used to transmit the management frame with the information of the roaming AP MLD with which 1^{st} AP MLD is affiliated and/or the other AP MLDs affiliated with the roaming AP MLD is referred to herein as the reporting AP MLD. The other AP MLDs affiliated with the same distributed AP MLD group as the reporting AP MLD are referred to herein as the reported AP MLDs when the information of the other AP MLDs are carried in the management frame of the reporting AP MLD. This is illustrated in FIG. 3, which shows the distributed AP MLD group 200 in accordance with an embodiment of the invention.

In FIG. 3, the non-AP MLD 11 has established a multi-link communication with the AP MLD 11 affiliated with the roaming AP MLD 1. Thus, the AP 111 or the AP 112 of the AP MLD 11 used for transmitting the management frame to carry the other AP MLD's information (e.g. the information of AP MLD12, 13, 14) is the reporting AP. As such, the AP MLD 11 is the reporting AP MLD, and the AP MLDs 12, 13 and 14 are the reported AP MLDs.

In an embodiment, one ESS, which may be a distributed AP MLD group, e.g., the distributed AP MLD group 200, can include any combination of one or more roaming AP MLDs, one or more AP MLDs and one or more APs. Thus, in this embodiment, more than one roaming AP MLDs can exist in a single ESS. As an example, in this embodiment, an ESS can include, but not limited to, (1) multiple roaming AP MLDs, (2) roaming AP MLDs and EHT AP MLDs, or (3) roaming AP MLDs, non-EHT AP and EHT AP MLDs. In an alternative embodiment, one ESS, which may be a distributed AP MLD group, e.g., the distributed AP MLD group 200, can include any combination of one roaming AP MLD, one or more AP MLDs and one or more APs. Thus, in this embodiment, at most one roaming AP MLDs can exist in a single ESS.

In an embodiment, only the AP MLDs affiliated with a roaming AP MLD are visible to an EHT non-AP MLD. Thus, the roaming AP MLD is not visible to an EHT non-AP MLD. For a UHR non-AP MLD, the AP MLDs affiliated with a roaming AP MLD, including the roaming AP MLD, are visible. Thus, for the distributed AP MLD group 200, only the AP MLDs 11, 12, 14 and 14 are visible to an EHT non-AP MLD. However, the AP MLDs 11, 12, 14 and 14, as well as the roaming AP MLD 1, are visible to a UHR non-AP MLD.

In an embodiment, all the APs affiliated with the AP MLDs that are affiliated with a roaming AP MLD have the same robust security network (RSN) element (RSNE) and RSN extension element (RSNXE) except authentication key management (AKM) Suite List field and the MFRP subfield. The following are RSNE capabilities for all the APs affiliated with an AP MLD and for the single RSNE capability element sent by a STA affiliated to a non-AP MLD:
No Pairwise: shall be set to 0 (must be 0 in practice)
PeerKey Enable: shall be set to 0
Management Frame Protection Capable (MFPC): shall be set to 1

In an embodiment, Management Frame Protection Required (MFPR) may differ between links because MFPR needs to be 0 on links that support legacy-non-6-GHz-STAs while it must be 1 on the 6 GHz band. This has no connection to how deauthentication/disassociation frames are used since use of management frame protection is determined based on MFPC, not MFPR.

In an embodiment, for a multi-link setup between a non-AP MLD and a roaming AP MLD through an AP MLD affiliated with the roaming AP MLD, the same Pairwise Master Key (PMK) and Pairwise Transient Key (PTK) with the same packet number (PN) space across all APs affiliated with the AP MLDs that are affiliated with the roaming AP MLD are used for individual data and management frames. The MAC SAP address of the roaming AP MLD is used to calculate the PMK and PTK, which can then be used for data and/or management frame exchanges, including making an association with the roaming AP MLD by the non-AP MLD.

In this embodiment, the authentication Request/Response, Extensible Authentication Protocol over Local Area Network (EAPOL) Key frame, Association Request/Response, Beacon and Probe Request/Response frames carry the roaming AP MLD's MAC SAP address (simplified to roaming AP MLD's MAC address) and the MAC SAP address of the AP MLD (i.e., the reporting AP MLD for roaming) with which the AP that transmits the authentication/Beacon frame is affiliated. In one embodiment, the MAC addresses of the other AP MLDs that are affiliated with the roaming AP MLD (reported AP MLDs) are not carried in the authentication frame, EAPOL frames, Association frames for the authentication/verification. In one embodiment, the MAC addresses of the other AP MLDs that are affiliated with the roaming AP MLD (reported AP MLDs) are carried in the authentication frame, EAPOL frames, Association frames for the authentication/verification.

In this embodiment, when the AP MLD switches (roams) from one AP MLD (the current serving AP MLD) affiliated with a roaming AP MLD to another AP MLD (the new serving AP MLD) affiliated with the same AP MLD, the link addresses of the roamed (new serving) AP MLD are carried in a protected roaming action frame. An example of a roamed AP MLD is illustrated in FIG. 2 where the non-AP MLD 11 has roamed from the AP MLD 11 to the AP MLD 12. Thus, the AP MLD 11 is the AP MLD for data exchanges and the AP MLD 12 is the roamed AP MLD.

As noted above, for an EHT non-AP MLD, a roaming AP MLD is not visible to the EHT non-AP MLD that supports EHT protocol only. The reason why this is desirable is that if a roaming AP MLD is visible to an EHT non-AP MLD, all the APs of the distributed AP MLDs affiliated with the roaming AP MLD will be assumed to belong to the roaming AP MLD, which may include multiple APs with the same channel. However, an EHT non-AP MLD that supports EHT protocol only will treat a roaming AP MLD with multiple APs working on the same channel as an AP MLD that is not in line with the 802.11 specification. In order for a roaming AP MLD to be transparent or not visible to an EHT non-AP MLD, a roaming AP MLD announcement can be made that is different from the AP MLD announcement in Basic Multi-Link element.

In a first embodiment, in order to make a roaming AP MLD announcement invisible to the EHT non-AP MLDs that support EHT protocol only, an AP indicates whether it is affiliated with an AP MLD that is affiliated with a roaming AP MLD through the basic multi-link element transmitted by the AP to carry the roaming AP MLD information. This indication may be carried in the new defined subfield of common information field of the basic multi-link element, which is not understood by EHT non-AP MLDs. The MAC SAP address of the roaming AP MLD is also carried in the basic multi-link element, e.g. in the common information field. The common information field can also carry the MLD identifier of the reported AP MLD for roaming within the roaming AP MLD.

In a second embodiment, in order to make a roaming AP MLD announcement, a new type of Multi-Link element, e.g. Roaming Multi-Link element, is defined to indicate whether an AP is affiliated with an AP MLD that is affiliated with a roaming AP MLD.

In addition, an announcement of the reported AP MLDs for roaming and their affiliated APs may be made, which is not understood by EHT non-AP MLDs. This announcement can be achieved in one of the following ways. In a first embodiment, Reduced Neighbor Report is used to carry the information of the APs affiliated with the reported AP MLD for roaming. In a second embodiment, the Roaming Multi-Link element is used to announce the reported AP MLDs for roaming and their affiliated APs. In a third embodiment, the Neighbor Report is used to announce the reported AP MLDs for roaming and their affiliated APs.

In an embodiment, a Roaming Multi-Link element carries a Common Info field and per MLD info fields. The Common Info field carries the information for roaming, e.g., the MAC SAP address of the roaming AP MLD and the MLD ID of the reporting MLD. The MLD ID of the reporting MLD can be carried in one of the per MLD info fields, which carry the information of the reporting AP MLD as one example. The MLD ID of the reporting MLD can be carried in the Common Info of a Roaming Multi-Link element as another example. The per MLD information carries or includes the common information of the reported AP MLD for roaming. The common information includes the MAC SAP address of the AP MLD and the MLD ID of the reported/reporting AP MLD for roaming. In one embodiment, the Per MLD information may also carry the per STA profiles of the reported AP MLD. Each per STA profile carries or includes the link information of the AP affiliated with the reported/reporting AP MLD for roaming, which may include AP's address, operating channel etc., for example.

When a non-AP MLD roams from one AP MLD (current serving AP MLD) affiliated with a roaming AP MLD to another AP MLD (new serving AP MLD) affiliated with the same roaming AP MLD, there is no need for a new association since the non-AP MLD made an association with the roaming AP MLD when the non-AP MLD establishes a multi-link connection with an AP MLD affiliated with the roaming AP MLD. However, various resources need to be managed under roaming to establish the frame exchange context of the non-AP MLD at the new serving AP MLD, as described below.

In an embodiment, after the roaming, the default traffic identifier (TID)-to-link mapping is applied unless the TID-to-Link mapping is negotiated during the roaming through Roaming Request/Response frames. The default TID-to-link mapping means that any two links of the roamed AP MLD can be used to transmit any TID.

In an embodiment, after the roaming, the block acknowledgment (BA) agreements are kept unless there is a requirement to change the BA agreement in which case the BA negotiation can be done within Roaming Request/Response frames. In an alternative embodiment, in order to use the BA agreements after the roaming, the BA agreements need to be negotiated during the roaming through the Roaming Request/Response frames.

In an embodiment, after the roaming, the enablement of emergency preparedness communications service (EPCS) is kept unless there is a requirement to change the EPCS enablement in which case the EPCS change can be done within Roaming Request/Response frames. In an alternative embodiment, in order to use the EPCS after the roaming, the enablement of EPCS needs to be negotiated during the roaming through the Roaming Request/Response frames.

In an embodiment, after the roaming, the stream classification service (SCS) agreement is kept unless there is a requirement to change the SCS agreement in which case the SCS negotiation can be done within the Roaming Request/Response frames. In an alternative embodiment, in order to use the SCS agreement after the roaming, the SCS agreement needs to be negotiated during the roaming through the Roaming Request/Response frames.

In an embodiment, after a non-AP MLD's roaming, the individual target wake time (TWT) agreement of a non-AP STA affiliated with the non-AP MLD is not kept unless there is a requirement to keep the individual TWT agreement in which case the TWT negotiation can be done within the Roaming Request/Response frames.

In an embodiment, after a non-AP MLD's roaming, the broadcast TWT membership of a non-AP STA affiliated with the non-AP MLD is not kept unless there is a requirement to becoming the broadcast TWT membership in which case the TWT negotiation can be done within the Roaming Request/Response frames.

The aforementioned TWT agreement during the roaming means that, when roaming from the current serving AP MLD to a new serving AP MLD, the individual and broadcast TWT agreement will be turned down, e.g., no TWT agreement with the new serving AP MLD unless the TWT agreement is negotiated in Roaming Request/Response frames.

In addition, when a non-AP MLD roams from one AP MLD affiliated with a roaming AP MLD to another AP MLD affiliated with the same roaming AP MLD, the power management needs to be addressed, as described below.

In an embodiment, after a non-AP MLD's roaming, the power management mode of each STA affiliated with the non-AP MLD is kept unless there is a requirement to change the power management mode in which case the power management mode change can be explicitly indicated within the Roaming Request/Response frames. If a STA of a non-AP MLD does not have an associated AP or is not in an established link after the roaming, the STA's power management mode is not needed.

In an embodiment, after a non-AP MLD's roaming, the awake/doze state of each STA affiliated with the non-AP MLD is kept. If a STA of a non-AP MLD does not have an associated AP or is not in an established link after the roaming, the STA's active/doze state is not needed. In a first alternative embodiment, the STA that transmits the Roaming Request or receives the Roaming Response with the AP of the new serving AP MLD is in an awake state, and the other STAs are in a doze state. In a second alternative embodiment, all the STAs of the non-AP MLD are in the doze state.

In an embodiment, after a non-AP MLD's roaming, the Listen Interval of the non-AP MLD is kept unless there is a requirement to change the Listen Interval in which case the Listen Interval change can be done within the Roaming Request/Response frames.

In an embodiment, after a non-AP MLD's roaming, the max idle period of the non-AP MLD is kept unless there is a requirement to change the max idle period in which case the max idle period change can be done within the Roaming Request/Response frames.

For roaming operations, Roaming Request and Roaming Response frames in accordance with embodiments of the invention may be used, as described below. In an embodiment, the roaming request frame can be a new defined Action frame (sometimes referred to herein as the Roaming Request). The request frame can carry the multi-level element for link level or MLD level roaming. The ML element can be a Basic Multi-Level element or a new variant of Multi-Level element. The request frame may carry various resource requests, e.g., link level and/or MLD level resources. For MLD level, the resource requests may include, but not limited to, BA agreement establishment, TID-to-link mapping, EPCS and SCS. For link level, the resource requests may include, but not limited to, TWT negotiation. The request frame can carry the indication that if the resource request is not accepted, the non-AP will withdraw the roaming or continue the roaming.

In an embodiment, the roaming response frame can be a new defined Action frame (sometimes referred to herein as the Roaming Response). The response frame can carry the indication whether the roaming request is accepted or not accepted. The response frame can carry the MLD level operating parameters and/or link level operating parameters of the roamed serving AP in the basic multi-link element. The parameters can be carried per the request of the non-AP MLD or per the decision of the roamed AP MLD. The response frame can carry the various established resources, e.g., link level and/or MLD level resources, per the request. For MLD level, the resource requests may include, but not limited to, BA agreement establishment, TID-to-link mapping, EPCS and SCS. For link level, the resource requests may include, but not limited to, TWT negotiation.

Link IDs for APs of distributed AP MLDs in a distributed AP MLD group in accordance with embodiment of the invention are now described. In a first embodiment, the links of each AP MLD (e.g., AP MLD 11 in FIG. 2) affiliated with a roaming AP MLD (e.g., roaming AP MLD 1 in FIG. 2) have their own link ID space (independently coded). Thus, the same link IDs associated with APs of one AP MLD affiliated with a roaming AP MLD may be used as the link IDs associated with APs of another AP MLD affiliated with the roaming AP MLD. As an example, in FIG. 2, the 5 GHz AP 111 and the 6 GHz AP 112 of the AP MLD 11 affiliated with the roaming AP MLD 1 may have link IDs of 0 and 1, respectively. The 5 GHz AP 121 and the 6 GHz AP 122 of the AP MLD 12 affiliated with the roaming AP MLD 1 may have the same link IDs of 0 and 1, respectively. Globally, a combination of the ID of the AP MLD and the link ID may be used to identify a particular link or AP in a distributed AP MLD group. Consequently, in the above example, the global ID of the 5 GHz AP 111 of the AP MLD 11 affiliated with the roaming AP MLD 1 would be the ID of the AP MLD 11, for example, 0, and the link ID of the 5 GHz AP 111, which will result in “00”. The global ID of the 5 GHz AP 121 of the AP MLD 12 affiliated with the roaming AP MLD 1 would be the ID of the AP MLD 12, for example, 1, and the link ID of the 5 GHz AP 121, which will result in “10”.

In a second embodiment, the links of all AP MLDs (e.g., AP MLD 11, AP MLD 12, AP MLD 13 and AP MLD 14 in FIG. 2) affiliated with a roaming AP MLD (e.g., roaming AP MLD 1) have one link ID space, i.e., each link of all AP MLDs has a unique link ID value. In this embodiment, the link of one AP MLD affiliated with a roaming AP MLD and the link of another AP MLD affiliated with the same roaming AP MLD cannot have the same link ID value.

An association ID (AID) for a non-AP MLDs associated with a roaming AP MLD in accordance with embodiment of the invention is now described. In a first embodiment, a non-AP MLD that is associated with a roaming AP MLD has one unique AID. When the non-AP MLD changes its AP MLD for its frame exchanges, the AID of the non-AP MLD does not change. Thus, in FIG. 2, if the non-AP MLD 11 had an AID of “10” when performing data exchanges with the AP MLD 11, the non-AP MLD 11 will maintain the same AID of “10” after roaming to the AP MLD 12.

In a second embodiment, each AP MLD affiliated with a roaming AP MLD allocates AID to each non-AP MLD that performs frame exchanges with the AP MLD. Thus, in FIG. 2, if the non-AP MLD 11 had an AID of “10” when performing data exchanges with the AP MLD 11, the non-AP MLD 11 will get a different AID from the AP MLD 12, for example, an AID of “32”.

Roaming operations between a roaming AP MLD and a UHR AP MLD and between roaming AP MLDs in accordance with an embodiment of the invention are now described. For roaming between a roaming AP MLD and an UHR AP MLD, the rules defined in U.S. patent application Ser. No. 18/499,783, titled “Handshake for Smooth Roaming,” which is incorporated herein by reference, can be used where the two AP MLDs are replaced by the roaming AP MLD and the UHR AP MLD, i.e., serving “roaming AP MLD” and hot-standby “UHR AP MLD”, or serving “UHR AP MLD” and hot-standby “roaming AP MLD”. In another embodiment, the FT (fast BSS transition) can be used.

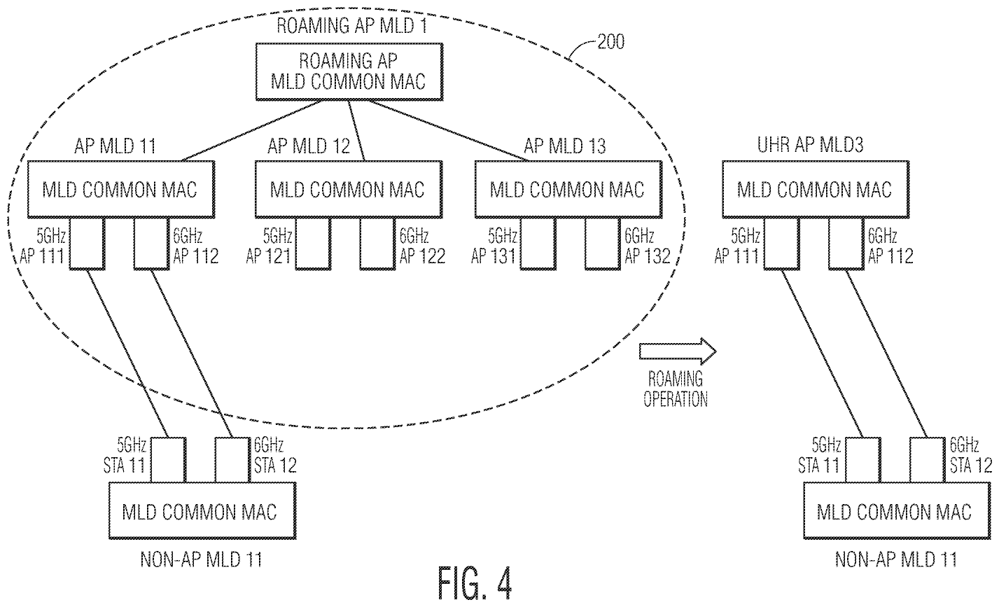

FIG. 4 illustrates a roaming operation between a roaming AP MLD and a UHR AP MLD in accordance with an embodiment of the invention. In FIG. 4, the non-AP MLD 11 is roaming from the AP MLD 11 affiliated with the roaming AP MLD 1 to a UHR AP MLD 3, which has AP 111 and AP 112. Thus, in FIG. 4, one AP MLD is replaced by the serving roaming AP MLD 1 and the other AP MLD is replaced by the hot-standby UHR AP MLD 3. If the non-AP MLD 11 is roaming from the UHR AP MLD 3 to the AP MLD 11 affiliated with the roaming AP MLD 1, then one AP MLD is replaced by the serving UHR AP MLD 3 and the other AP MLD is replaced by the hot-standby roaming AP MLD 1.

For roaming between two roaming AP MLDs, the rules defined in U.S. patent application Ser. No. 18/499,783, titled “Handshake for Smooth Roaming,” can be used where two AP MLD is replaced by two roaming AP MLDs, i.e. serving “roaming AP MLD” and hot-standby “roaming AP MLD”. In another embodiment, the FT (fast BSS transition) can be used.

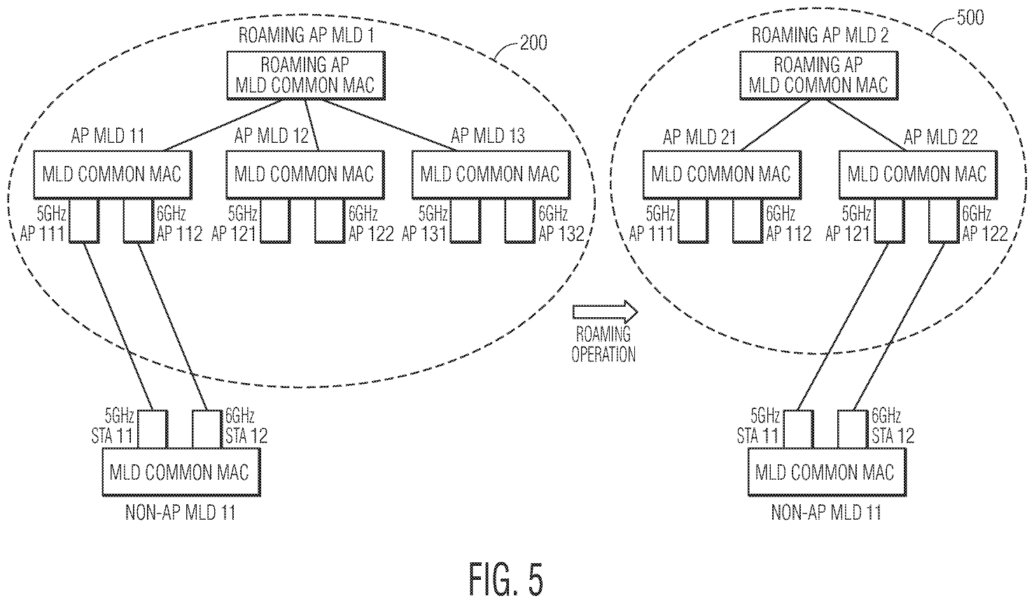

FIG. 5 illustrates a roaming operation between two roaming AP MLDs in accordance with an embodiment of the invention. In FIG. 5, the non-AP MLD 11 is roaming from the AP MLD 11 affiliated with the roaming AP MLD 1 to an AP MLD 22 affiliated with a roaming AP MLD 2, which is also affiliated with an AP MLD 21 as part of a distributed AP MLD group 500. The AP MLD 21 includes a 5 GHz AP 111 and a 6 GHz AP 112. Similarly, the AP MLD 22 includes a 5 GHz AP 121 and a 6 GHz AP 122. Thus, in FIG. 5, one AP MLD is replaced by the serving roaming AP MLD 1 and the other AP MLD is replaced by the hot-standby roaming AP MLD 1. If the non-AP MLD 11 is roaming from the AP MLD 22 to the AP MLD 11 affiliated with the roaming AP MLD 1, then one AP MLD is replaced by the serving roaming AP MLD 2 and the other AP MLD is replaced by the hot-standby roaming AP MLD 1.

Roaming using a distributed AP MLD group can be MLD level roaming or link level roaming in accordance with embodiments of the invention. In an embodiment, for MLD level roaming, after the roaming, all the links of a non-AP MLD are the setup links with a new AP MLD in a distributed AP MLD group to perform the frame exchanges. For link level roaming, after the roaming, some links of a non-AP MLD are the setup links of one AP MLD in the distributed AP MLD group to perform the frame exchanges while the other links of the non-AP MLD are the setup links with another AP MLD in the distributed AP MLD group to perform the frame exchanges. In one embodiment, the multiple serving AP MLDs are only allowed during the roaming stage for smooth roaming. In the first roaming through one pair of Roaming Request/Response exchange, some non-AP MLD's links are the setup links with the current serving AP MLD and the other non-AP MLD's links are the setup links with the new serving AP MLD. In the second roaming through another pair of Roaming Request/Response exchange, the remaining non-AP MLD's links with the current serving AP MLD become the setup links with the new serving AP MLD. As an example, one of the two links of a non-AP MLD may be roamed from a first AP MLD in the distributed AP MLD group to a link of a second AP MLD in the distributed AP MLD group. Then, the other link of the non-AP MLD may be roamed from the first AP MLD in the distributed AP MLD group to the other link of the second AP MLD in the distributed AP MLD group, which completes the roaming operation from the first AP MLD to the second AP MLD. In another embodiment, the multiple serving AP MLDs of a non-AP MLD can exist when the non-AP MLD does the normal frame exchanges without being in the roaming stage.

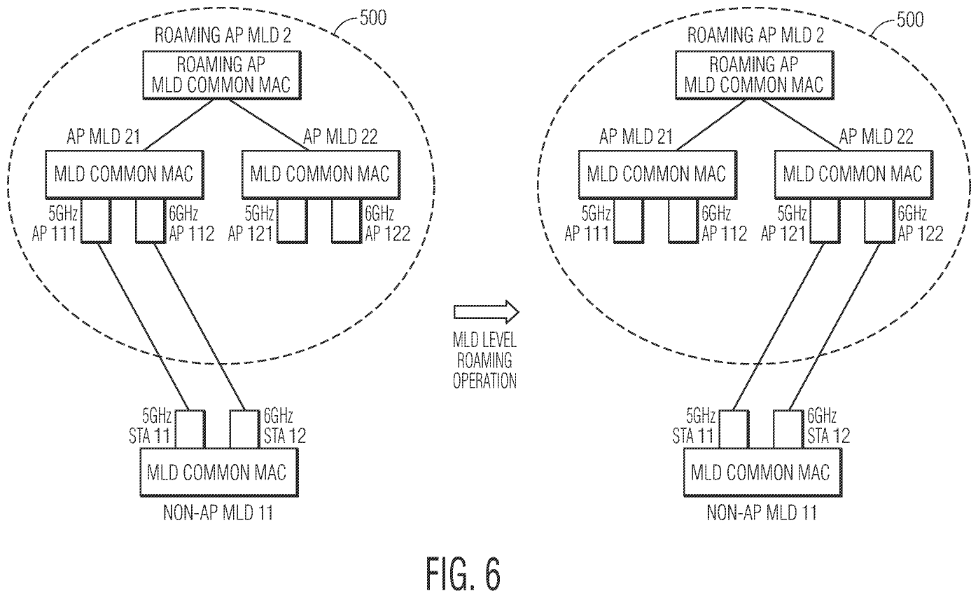

FIG. 6 illustrates an MLD level roaming operation sequence in accordance with an embodiment of the invention. In FIG. 6, the non-AP MLD 11 is roaming from the AP MLD 21 affiliated with the roaming AP MLD 2 to the AP MLD 22 affiliated with the roaming AP MLD 2. Prior to the MLD level roaming operation, both links of the non-AP MLD 11 are the setup links of the AP MLD 21. After the MLD level roaming operation through one Roaming Request/Response exchange, both links of the non-AP MLD 11 use the links of the AP MLD 22.

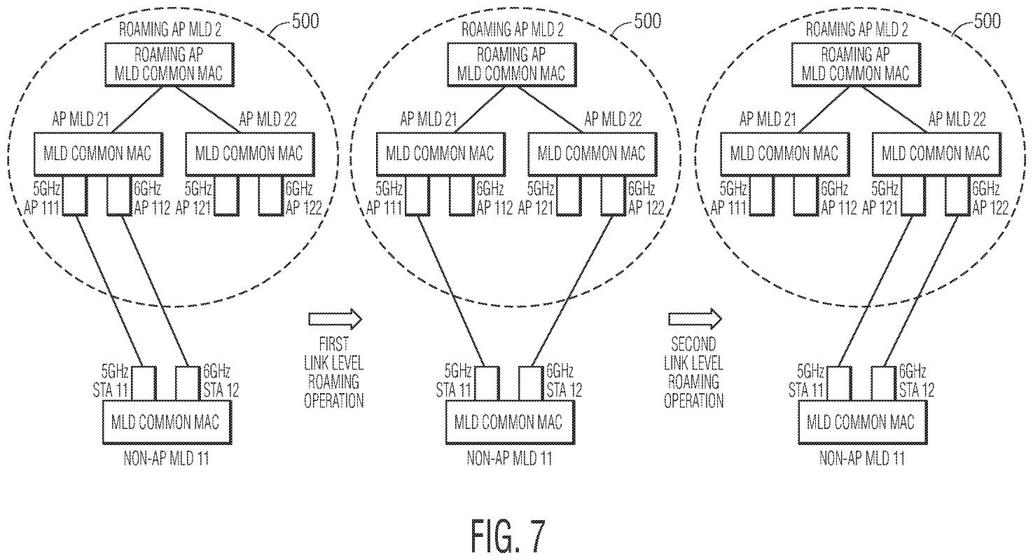

FIG. 7 illustrates a link level roaming operation sequence in accordance with an embodiment of the invention. As shown in FIG. 7, prior to the link level roaming operation, both links of the non-AP MLD 11 use the links of the AP MLD 21. Thus, the 5 GHz STA 11 of the non-AP MLD 11 is linked to the 5 GHz AP 111 of the AP MLD 21, and the 6 GHz STA 12 of the non-AP MLD 11 is linked to the 6 GHz AP 112 of the AP MLD 21. After a first link level roaming operation through the first Roaming Request/Response exchange, one of the links of the non-AP MLD 11 is the setup link with the AP MLD 22. Thus, the 5 GHz STA 11 of the non-AP MLD 11 is still linked to the 5 GHz AP 111 of the AP MLD 21, and the 6 GHz STA 12 of the non-AP MLD 11 is linked to the 6 GHz AP 122 of the AP MLD 22. After a second link level roaming operation through the second Roaming Request/Response exchange, the other link of the non-AP MLD 11 switches to the AP MLD 22 so that both links of the non-AP MLD 11 are the setup links of the AP MLD 22.

The per-link level roaming provides smoother data frame exchanges than per-MLD level roaming. For link level roaming, the BA Buffer reordering needs to be in a common place of different MLDs (i.e., roaming AP MLD level). One exception for such requirement is that with different TIDs mapped to different links for a non-AP MLD, each TID will not be mapped to the links of different AP MLDs. The AP MLDs affiliated with the roaming AP MLD may be difficult to implement this feature. The link pair at a non-AP MLD that is associated with APs in different AP MLDs may be non-simultaneous transmit and receive (NSTR) link pair. For such a link pair, it may be difficult to perform the PPDU alignment in the link pair with the APs in different AP MLDs.

For MLD level roaming, the reordering of a BA agreement is done at AP MLD level. In addition, the simultaneous transmit and receive (STR)/NSTR link pair is serviced by the APs in one AP MLD. The rules in 802.11be can be used for the process. Furthermore, the frame exchanges may be interrupted when doing MLD level roaming.

A roaming AP MLD may announce the disablement of link-level roaming among the AP MLDs affiliated with the roaming AP MLD. In an embodiment, the announcement can be in the Common Info field of the Multi-Link element. In other embodiments, the announcement can be in a new defined element transmitted in the Beacon, Probe Response and/or Association Response frames. The roaming AP MLD may announce an exception for non-AP MLDs that support different TIDs being mapped to different links. When performing link level roaming, the TID to link mapping where any TID cannot be mapped to the links of different AP MLDs may be negotiated.

In an embodiment, if a non-AP MLD found that its link pair is an NSTR link pair when the link pair associates with two links of two AP MLDs, the non-AP MLD cannot or is not allowed to perform the link level roaming through the link pair. If a roaming AP MLD announces the disabling of link level roaming between two AP MLDs affiliated with the roaming AP MLD, the non-AP MLD cannot or is not allowed to perform the link level roaming between the two AP MLDs affiliated with the roaming AP MLD.

In an embodiment, If a non-AP MLD found that its link pair is an NSTR link pair when the link pair associates with two links of two AP MLDs, the non-AP MLD can still do the link level roaming through the link pair. In this embodiment, the PPDUs in the link pair from the APs have no ending time alignment requirement, i.e., the ending time of the PPDUs do not need to be same. The ending time difference of the PPDUs can be more than the predefined threshold, e.g., ½ SIFS.

In an embodiment, a new Action frame with updated Reconfiguration Multi-Link element, as defined by 801.11be, can be used for link level or MLD level roaming. The deleting/adding of links can be announced in the same Action frame. The resource negotiation can be carried as the subelement of a Reconfiguration Multi-Link element. Alternatively, the resource negotiation can be carried in a separate element.

In an embodiment, the serving AP MLD affiliated with a roaming AP MLD of a non-AP MLD may send a roaming recommendation to the non-AP MLD to switch to another AP MLD affiliated with the roaming AP MLD. In an alternative embodiment, a roaming AP MLD may send a roaming recommendation to a non-AP MLD through the serving AP MLD of the non-AP MLD to request the MLD switch to another AP MLD affiliated with the roaming AP MLD. The roaming recommendation may also indicate the roaming type (link level roaming or MLD level roaming).

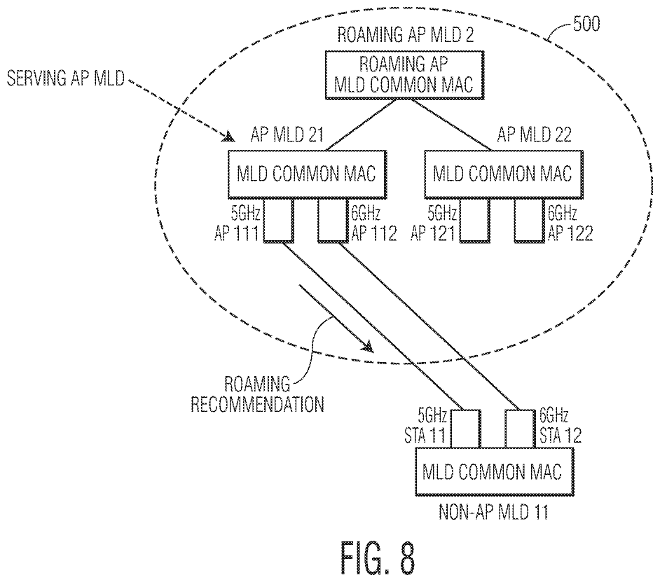

FIG. 8 illustrates a roaming recommendation operation in accordance with an embodiment of the invention. In FIG. 8, the AP MLD 21 is the serving AP MLD affiliated with the roaming AP MLD 2 of the non-AP MLD 11. As shown in FIG. 8, the AP MLD 21 as the serving AP MLD sends a roaming recommendation to the non-AP MLD 11.

Fast BSS transition (FT) operation between a roaming AP MLD and an EHT AP MLD in accordance with an embodiment of the invention is now described. In the FT key architecture, 4-way handshake for FT to a roaming AP MLD, the MAC SAP address of roaming AP MLD is used the same way as the MAC SAP address of the AP MLD in the FT key architecture, 4-way handshake for FT to an AP MLD.

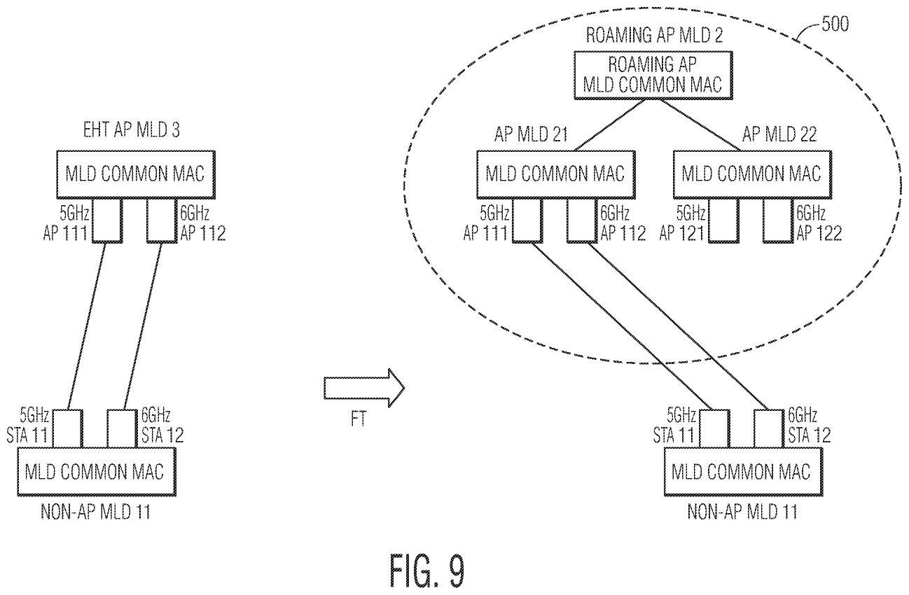

FIG. 9 illustrates an FT operation between a roaming AP MLD and an EHT AP MLD in accordance with an embodiment of the invention. In FIG. 9, the non-AP MLD 11 is performing a FT operation from an EHT AP MLD 3 to the AP MLD 21 affiliated with the roaming AP MLD 2. In this operation, the MAC SAP address of the roaming AP MLD 2 is used for the 4-way handshake for FT to an AP MLD.

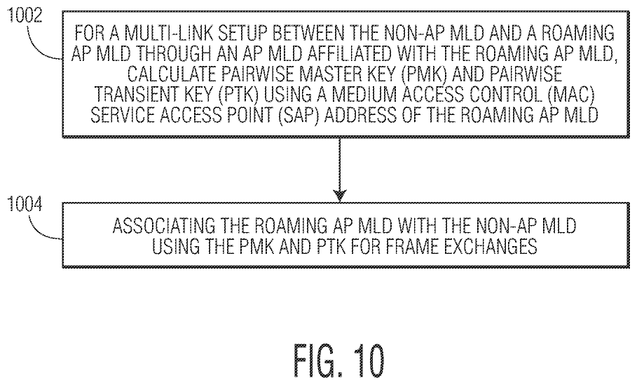

A method of roaming for a non-AP device involving a roaming AP MLD that is affiliated with a plurality of AP MLDs at different locations in accordance with an embodiment of the invention is described with reference to a flow diagram of FIG. 10. At block 1002, for a multi-link setup between the non-AP MLD and the roaming AP MLD through an AP MLD affiliated with the roaming AP MLD, Pairwise Master Key (PMK) and Pairwise Transient Key (PTK) are calculated using a medium access control (MAC) service access point (SAP) address of the roaming AP MLD. At block 1004, the roaming AP MLD is associated with the non-AP MLD using the PMK and PTK for frame exchanges.

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Unless otherwise indicated, all numbers expressing parameter values and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having” and/or the like are intended to be open-ended terms. Further, the phrase “based on” is intended to mean “based, at least in part, on” unless explicitly stated otherwise.

What is claimed is:

1. A distributed access point (AP) multi-link device (MLD) apparatus comprising:
a roaming AP MLD having a medium access control (MAC) service access point (SAP) address; and
a plurality of AP MLDs affiliated with the roaming AP MLDs,
wherein at least one of the roaming AP MLD and the AP MLDs is operable to, for a multi-link setup between a non-AP MLD and the roaming AP MLD through one of the AP MLDs affiliated with the roaming AP MLD, calculates Pairwise Master Key (PMK) and Pairwise Transient Key (PTK) using the MAC SAP address of the roaming AP MLD and allow the non-AP MLD to be associated with the roaming AP MLD using the PMK and PTK for frame exchanges.

2. The distributed AP MLD apparatus of claim 1, wherein at least one of the roaming AP MLD and the AP MLDs is configured so that the roaming AP MLD is not visible to an extreme high throughput (EHT) non-AP MLD.

3. The distributed AP MLD apparatus of claim 2, wherein an AP of the AP MLDs is configured to make a roaming AP MLD announcement in a Basic Multi-Link element or a Roaming Multi-Link element to indicate whether the AP is affiliated with an AP MLD that is affiliated with the roaming AP MLD.

4. The distributed AP MLD apparatus of claim 3, wherein the AP of the AP MLDs is configured to make an announcement of some of the AP MLDs for roaming and their affiliated APs.

5. The distributed AP MLD apparatus of claim 1, wherein the roaming AP MLD is part of extended service set (ESS) that can only have one roaming AP MLD.

6. The distributed AP MLD apparatus of claim 1, wherein at least one of the roaming AP MLD and the AP MLDs is configured so that an existing resource is kept after the non-AP MLD has roamed to one of the AP MLDs unless there is a negotiation during roaming or a requirement to change the existing resource, the existing resource being a traffic identifier (TID)-to-link mapping, a block acknowledgement (BA) agreement, an enablement of emergency preparedness communications service (EPCS), a stream classification service (SCS) agreement, an individual target wake time (TWT) agreement associated with the non-AP MLD or a broadcast TWT membership associated with the non-AP MLD.

7. The distributed AP MLD apparatus of claim 6, wherein at least one of the roaming AP MLD and the AP MLDs is configured so that the existing resource is changed using Roaming Request and Roaming Response frames.

8. The distributed AP MLD apparatus of claim 1, wherein at least one of the roaming AP MLD and the AP MLDs is configured so that, in order to use an existing resource after roaming of the non-AP MLD to one of the AP MLDs, the existing resource needs to be renegotiated during roaming using Roaming Request and Roaming Response frames, the existing resource being a BA agreement, an enablement of EPCS, a SCS agreement, an individual TWT agreement associated with the non-AP MLD or a broadcast TWT membership associated with the non-AP MLD.

9. The distributed AP MLD apparatus of claim 1, wherein at least one of the roaming AP MLD and the AP MLDs is configured so that, when roaming of the non-AP MLD to one of the AP MLDs, an existing resource needs to be renegotiated during roaming using Roaming Request and Roaming Response frames, the existing resource being a BA agreement, an enablement of EPCS, a SCS agreement, a TWT agreement associated with the non-AP MLD or a broadcast TWT membership associated with the non-AP MLD.

10. The distributed AP MLD apparatus of claim 1, wherein the AP MLDs are configured so that each link of the AP MLDs has a unique link identifier (ID) value.

11. The distributed AP MLD apparatus of claim 1, wherein each of the AP MLDs is configured to allocate an association identifier (AID) to the non-AP MLD that performs frame exchanges with that AP MLD.

12. The distributed AP MLD apparatus of claim 1, wherein at least one of the roaming AP MLD and the AP MLDs is configured so that the non-AP MLD is allowed or not allowed to perform link level roaming using one or more announcements.

13. The distributed AP MLD apparatus of claim 1, wherein at least one of the roaming AP MLD and the AP MLDs is configured so that Physical Layer Convergence Protocol (PLCP) Protocol Data Units (PPDUs) in a link pair from APs of the AP MLDs have no ending time alignment requirement to allow link level roaming even when the link pair is a non-simultaneous transmit and receive (NSTR) link pair.

14. A method of roaming for a non-AP device involving a roaming AP MLD that is affiliated with a plurality of AP MLDs at different locations, the method comprising:
for a multi-link setup between the non-AP MLD and the roaming AP MLD through an AP MLD affiliated with the roaming AP MLD, calculating Pairwise Master Key (PMK) and Pairwise Transient Key (PTK) using a medium access control (MAC) service access point (SAP) address of the roaming AP MLD; and
associating the roaming AP MLD with the non-AP MLD using the PMK and PTK for frame exchanges.

15. The method of claim 14, further comprising making a roaming AP announcement so that the roaming AP MLD is not visible to an extreme high throughput (EHT) non-AP MLD.

16. The method of claim 14, wherein the roaming AP MLD announcement is made in a Basic Multi-Link element or a Roaming Multi-Link element by an AP to indicate whether the AP is affiliated with an AP MLD that is affiliated with the roaming AP MLD.

17. The method of claim 14, further comprising keeping an existing resource after the non-AP MLD has roamed to one of the AP MLDs unless there is a negotiation during roaming or a requirement to change the existing resource, the existing resource being a traffic identifier (TID)-to-link mapping, a block acknowledgement (BA) agreement, an enablement of emergency preparedness communications service (EPCS), a stream classification service (SCS) agreement, an individual target wake time (TWT) agreement associated with the non-AP MLD or a broadcast TWT membership associated with the non-AP MLD.

18. The method of claim 17, further comprising changing the existing resource using Roaming Request and Roaming Response frames.

19. The method of claim 14, further comprising defining PPDUs in a link pair from APs of the AP MLDs to have no ending time alignment requirement to allow link level roaming even when the link pair is a NSTR link pair.

20. A multi-link communications system comprising:
a roaming AP MLD having a medium access control (MAC) service access point (SAP) address; and
a plurality of AP MLDs affiliated with the roaming AP MLDs, each of the AP MLDs including APs,
wherein PMK and PTK used by at least one of the roaming AP MLD and the AP MLDs are calculated using the MAC SAP address of the roaming AP MLD and a non-AP MLD is associated with the roaming AP MLD when the non-AP MLD has established a multi-link connection with the roaming AP MLD through an AP MLD affiliated with the roaming AP MLD.
